(19) United States
(12) Patent Application Publication
(10) Pub. No.: US 2006/0047551 A1
(43) Pub. Date: Mar. 2, 2006

(54) System and method for staffing promotional events with qualified event personnel

(76) Inventors: Sandra Cotten, Huntington Beach, CA (US); Caroline Nakken, Whittier, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/022,129

(22) Filed: Dec. 23, 2004

Related U.S. Application Data
(60) Provisional application No. 60/604,678, filed on Aug. 26, 2004.

(51) Int. Cl. G06F 9/46

(52) U.S. Cl. 705/8

(57) ABSTRACT

Systems and methods coordinate the attributes of event personnel with the needs of particular promotional events. Event profiles for promotional events specify one or more desired attributes for event operators to staff the event. Employee profiles also record the attributes of a plurality of event personnel. The event profiles are compared with the employee profiles to identify those event operators who are qualified to staff the promotional events. Qualified event operators are then assigned to participate in the promotional events. Preferably, qualified event personnel can register for events using, for example, a web page. Preferably, event personnel are given an incentive to register using the web page. In particular embodiments, event personnel can use the same web page or can use a different web page to generate their respective employee profiles.

### RELATED APPLICATIONS

This application claims the benefit under 35 USC § 119(e) of U.S. Provisional Application No. 60/604,678, filed Aug. 26, 2004, which is hereby incorporated herein in its entirety.

### BACKGROUND OF THE INVENTION

1. Field of the Invention

The invention relates to systems and methods for remotely managing promotional events. The invention also relates to systems and methods for assigning qualified event personnel to participate in a promotional event.

2. Description of the Related Art

Product manufacturers, distributors, marketers, and the like use event coordinators to coordinate product or service demonstrations in public areas such as retail stores or public parks. In a typical scenario, the event coordinator organizes promotional or marketing events wherein event personnel distribute or demonstrate products or services within retail stores or in a public park on a given date during a given time interval. The event coordinator may also distribute to the event personnel sample products or other materials to be used by the event personnel during the promotional event.

For example, a food manufacturer may ask an event coordinator to coordinate a promotional event where its food product is prepared and distributed as samples in hundreds or thousands of retail stores located throughout the United States or elsewhere. To staff the various events, the event coordinator typically hires one or more agencies, as needed, that employ event personnel for the purpose of working at promotional events. For a large promotion in stores around the country, many agencies may be used. The event coordinator may provide the event personnel with requirements or instructions for the event personnel to prepare and distribute the food product in specific retail stores at specific times as called for by the promotional event. The event coordinator may also provide the event personnel with, for example, sample food product to prepare and distribute, disposable utensils to distribute with the food samples, sanitary gloves to use when handling the food product, coupons to distribute with the food samples, promotional items and advertisements to display when preparing and distributing the food product, combinations of the foregoing, or the like.

The event personnel are typically employees of an agency contracted by the event coordinator. Typically, the event coordinator utilizes an agency's event personnel because the event coordinator does not have its own employees located in the geographical locale in which the products or services are to be demonstrated. Therefore, event coordinators are generally not aware of the skills or characteristics of the particular event personnel assigned to an event by an agency. Furthermore, it is not easy for the event coordinator to determine whether an agency has properly identified event personnel with the attributes needed for a particular promotional event. In many cases, agencies are not aware of the skills or characteristics of their own event personnel that would be beneficial for a particular event. As a result, the effectiveness of promotional events may be compromised by poor staffing choices that provide event personnel unsuitable for the needs of the promotional event.

### SUMMARY OF THE INVENTION

The present invention relates to systems and methods for coordinating the characteristics or skills of event personnel with the requirements of particular marketing or promotional events. According to an embodiment of the invention, a method is provided for facilitating the staffing of promotional events with qualified event personnel. The method includes creating a database comprising event data that includes schedule information for one or more promotional events. The event data also includes qualifications for event personnel associated with the one or more promotional events. The method further includes receiving a first request from a user seeking to be staffed at the one or more promotional events and determining a set of qualifications associated with the user. The event data is filtered based at least in part on the qualifications of the user to identify one or more of the promotional events for which the user is qualified to participate. The user is provided with schedule information for promotional events for which the user is qualified to participate as identified through the filtering of the event data, wherein the information is provided through at least one web page.

In an embodiment, a system for booking promotional events is provided. The system includes a database comprising event fields corresponding to one or more promotional events, employee fields corresponding to an event operator, and schedule information for coordinating the event operator's participation in booked events selected from the one or more events. The system also includes a server that provides the event operator with remote access to the database via a web page. The server is configured to compare the event fields to the employee fields and to receive a request from the event operator to update the schedule information based at least in part on the comparison.

The present invention also includes a method of registering for promotional events over a computer network by generating event profiles corresponding to respective promotional events. The event profiles include specified event personnel attributes. The method includes generating an employee profile comprising the event operator's attributes and comparing the event profiles to the employee profile. In response to the step of comparing, at least one of the promotional events that the event operator is qualified to participate in is displayed through a remote interface. A request is then received through the remote interface to assign at least one of the displayed promotional events to the event operator.

In an embodiment, a method of removing a promotional event from an event operator's schedule is provided. The method includes providing a user interface to an event operator over a computer network. The user interface is configured to provide remote access to a database comprising a schedule having a first event that the event operator is registered to participate in. The method also includes receiving a request over the computer network to remove the first event from the schedule and querying whether a time block corresponding to the first event can be rescheduled with a second event. If the time block can be rescheduled, the method includes indicating to the event operator through the user interface that the time block is available to be rescheduled with the second event.

In an embodiment, a method of coordinating promotional events is provided. The method includes (a) for each of a plurality of event operators seeking to be staffed at promotional events, generating and storing an employee profile for the event operator that includes personnel attributes for subsequently determining whether the event operator may qualify to be staffed at particular promotional events; (b) receiving an order to staff a promotional event; (c) receiving an event profile corresponding to the promotional event, wherein the event profile specifies at least one attribute of event personnel qualified to participate in the promotional event; (d) comparing the event profile received to the employee profiles generated and stored for the plurality of event operators; (e) in response to (d), identifying one or more qualified event operators; and (f) assigning the one or more qualified event operators to participate in the promotional event.

In an embodiment, a system for staffing promotional events is provided. The system includes a database comprising an event profile corresponding to a promotional event. The event profile specifies at least one attribute of event personnel qualified to participate in the promotional event. The database also comprises a plurality of employee profiles comprising event personnel attributes. The system further comprises a computer configured to compare the event profile to the plurality of employee profiles to identify one or more qualified event operators. The computer is further configured to assign the one or more qualified event operators to participate in the promotional event.

In an embodiment, a method of coordinating promotional events is provided. The method includes generating a plurality of employee profiles comprising attributes of respective event personnel and receiving an event profile through a computer network. The event profile specifies at least one attribute of an event operator qualified to participate in a promotional event. The method also includes searching the plurality of employee profiles to identify at least one of the event personnel who matches the event profile and assigning the identified event operator to participate in the promotional event.

In another embodiment, a system for coordinating promotional events is provided. The system comprises means for generating an event profile corresponding to a promotional event, means for generating a plurality of employee profiles, means for comparing the event profile to the plurality of employee profiles, wherein the means for comparing is configured to identify at least one of the employee profiles that satisfies requirements specified by the event profile, and means for scheduling an event operator corresponding to the at least one of the employee profiles to conduct the promotional event.

In another embodiment, a computer-implemented method of gathering event personnel attributes from an event operator seeking to be staffed at promotional events is provided. The method comprises providing a graphical user interface accessible over a computer network containing selectable entries for a plurality of personnel attributes associated with promotional events and receiving from the event operator selections from one or more of the selectable entries. The event operator accesses the graphical user interface over a computer network. The method further comprises storing the event operator selections and associating the event operator selections with an identifier assigned to the event operator.

In an embodiment, a system for gathering event personnel attributes from an event operator seeking to be staffed at promotional events is provided. The system includes a graphical user interface in communication with a computer network. The graphical user interface contains selectable entries for a plurality of personnel attributes associated with promotional events. The system also includes a first database in communication with the graphical user interface. The first database is configured for storing personnel attribute selections from event operators accessing the graphical user interface. The system further includes a second database in communication with the first database. The second database contains an identifier associated with the event operator and further associated with the personnel attribute selections of the event operator stored in the first database.

Other features and advantages of the present invention will become apparent to those of ordinary skill in the art through consideration of the following description, the accompanying drawings, and the appended claims. Not all of the features or advantages described above or discussed below are required in any particular embodiment of the present invention. Neither this summary nor the following detailed description purports to define the invention. The invention is defined by the claims.

### BRIEF DESCRIPTION OF THE DRAWINGS

A system and method which embodies the various features of the invention will now be described with reference to the following drawings, in which:

FIG. 1 is a block diagram that illustrates the relationships between some of the entities involved in marketing events;

FIG. 2 is a block diagram of a system according to an embodiment of the invention for coordinating a marketing event;

FIG. 3 illustrates exemplary event fields usable by an event coordinator system or agency system according to an embodiment of the invention;

FIG. 4 illustrates exemplary personnel fields usable by an event coordinator system or agency system according to an embodiment of the invention;

FIG. 5A is a representation of an exemplary web page for entering profile information into a system according to an embodiment of the invention;

FIG. 5B is a representation of an exemplary embodiment of a web page for booking events;

FIG. 6 is a flow chart illustrating portions of an event coordination process usable by the system shown in FIG. 2 according to an embodiment of the invention;

FIG. 7 is a flow chart illustrating portions of an event booking process usable by the system shown in FIG. 2 according to an embodiment of the invention;

FIG. 8 generally illustrates an example of a user interface that is usable to generate an event profile according to an embodiment of the invention;

FIG. 9 generally illustrates an example of a user interface that is usable to generate an employee profile according to an embodiment of the invention;

FIG. 10 generally illustrates an example of a user interface for coordinating events according to an embodiment of the invention, and

FIG. 11 generally illustrates an example of a user interface for creating, viewing or altering employee information according to an embodiment of the invention.

### DETAILED DESCRIPTION OF THE PREFERRED EMBODIMENT

The present invention relates to systems and methods for coordinating the characteristics or skills of event personnel with the requirements of particular promotional events. Promotional events in public locations, such as in stores or public parks, are a common way of generating buyer interest in a product. For example, a food company may attempt to generate customers for a new product by offering free samples at a table near the location of the product within grocery stores. Depending upon the desires of the food company, the samples may be provided in a few stores in selected cities, or in thousands of stores nationwide.

Some promotional events are more successful if the event personnel have skills related to using a particular product. For example, a skilled chef may be better qualified to demonstrate the use of cooking utensils than a person who does not know how to cook or handle the utensils. Some promotional events are more successful if the event personnel are selected based on the target consumer. For example, a person who is bald is likely to be less successful at promoting hair care products than a person with a healthy head of hair. Further, some promotional events ask the event personnel to provide equipment for the event. For example, event personnel may be asked to provide their own microwave, toaster oven, electric frying pan, or the like at an event where food is prepared.

In an embodiment of the invention, a computerized promotional event coordination system is provided that facilitates assigning qualified event personnel to promotional events, providing event materials, if any, to the assigned event personnel, tracking the promotional events, and paying the assigned event personnel. The system enables an event coordinator to generate an event profile that defines, for example, one or more attributes of event personnel who will staff a corresponding promotional event. The system also enables an event coordinator, agency or particular event personnel (an “event operator”) operator to generate an employee profile that includes one or more attributes of the event personnel. The event profiles and the employee profiles may include event personnel attributes such as physical characteristics, skills, or other qualifications. The system is configured to compare an event profile with the employee profiles to determine qualified event personnel for a particular promotional event.

The physical characteristics may include, for example, gender, eye color, hair length, hair type (e.g., curly, wavy or straight), hair color, weight, height, clear skin (e.g., no marks, scars, tattoos, acne, or the like), full range of motion, other physically descriptive qualities or the like. The skills or roles may include, for example, actor or actress, athlete, cheerleader, chef (amateur or professional), computers, cosmetologist (amateur or licensed), costumes, dancer, grandparent, hair colorist, hair stylist (amateur or licensed), installer, handy person, leader, magician, masseur or masseuse (amateur or professional), multilingual, musician (amateur or professional), nutritionist (amateur or licensed), parent, pet owner, standard event operator, singer (amateur or professional), skin care, veterinarian, other hobbies, occupations, talents or skills, or the like.

The other qualifications may include, for example, agreeing to provide equipment for demonstrations such as a microwave, toaster oven, electric frying pan, table, utensils, or the like. The exemplary attributes discussed above, including physical characteristics, skills and other qualifications, are provided for exemplary reasons only and are not intended to limit or construe the disclosure or claims. In fact, an artisan will recognize from the disclosure herein many possible physical characteristics, skills or other qualifications that can be used.

The system is configured to allow an event coordinator to select event personnel attributes included in the event profile based at least in part on the specifications of a product manufacturer, distributor, marketer, or the like. The event profile can then be provided, for example, through a network to an agency assigned to the promotional event. Employee profiles can also be provided, for example, through the network to the event coordinator.

In certain embodiments, the system includes a plurality of graphical user interfaces accessible over a network. The graphical user interfaces may include, for example, HTML web pages or the like. The graphical user interfaces may provide access to the system, or portions thereof, to an event coordinator, an agency, a product manufacturer, an event operator, or combinations of the foregoing.

An event operator may access a first graphical user interface over a network such as the Internet using, for example, an Internet browser. The event operator can use the first graphical user interface to schedule promotional events to participate in. The system is configured to prevent the event operator from scheduling promotional events that the event operator is not qualified for or that are at the same time or within a predetermined time frame of promotional events previously scheduled by the event operator. The event operator may not be qualified for a promotional event if, for example, the promotional event is assigned to an agency that the event operator does not work for, the promotional event is not at a place or within a time frame selected by the event operator, or the employee profile corresponding to the event operator does not match or is not sufficiently similar to the event profile.

In some embodiments, the event operator can access a second graphical user interface over the network. The event operator can use the second graphical user interface to create or modify an employee profile corresponding to the event operator. In addition, or in alternative embodiments, the employee profile is created or modified by the event coordinator or the agency that the event operator works for.

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent components and methods to those described herein. In other instances, well-known components and methods have not been described in detail so as to not unnecessarily obscure aspects of the present invention.

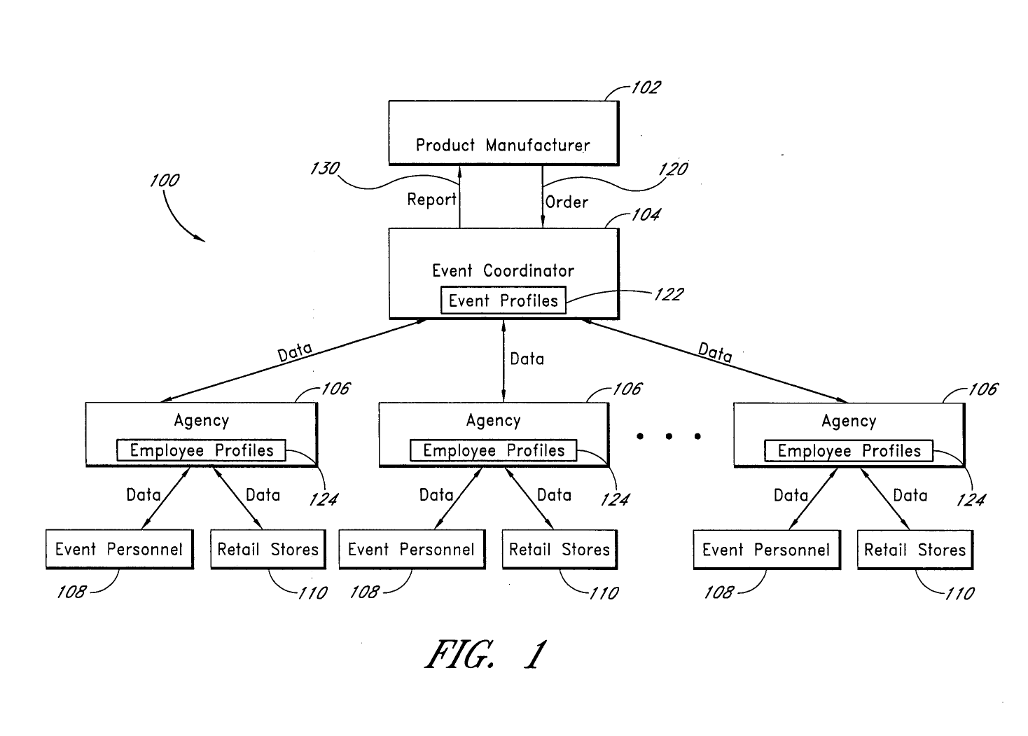

FIG. 1 is a block diagram that illustrates the relationships 100 between some of the entities involved in marketing events. The entities include a product manufacturer 102, an event coordinator 104, agencies 106, event personnel 108 and retail stores 110. The product manufacture 102 can also be a distributor, a marketer, a service provider, or the like. A service provider can be, for example, a travel agency, a transportation company, a financial brokerage firm, a real estate agency, an Internet service provider or other communication service provider, or the like.

In an embodiment, the product manufacturer 102 places an order 120 with the event coordinator 104 to coordinate promotional events for products at one or more event locations (e.g., the retail stores 110). A service vendor can also place an order 120 with the event coordinator 104 to coordinate promotional events for a particular service. The order 120 can include, for example, budget information, event locations, number of event locations, timing information, number of samples to be distributed, advertisements to be displayed at the events, characteristics or skills of event personnel, or the like.

The event coordinator 104 receives the order 120 and defines one or more promotional events that correspond to specific demonstrations at particular times and locations. In defining the promotional events, the event coordinator 104 generates versions of the events that specify products, general guidelines, materials to be used, materials to be shipped to the agencies 106 or event personnel 108, and variations of instructions corresponding to the different versions. The event coordinator 104 can generate packages or kits including the materials to be shipped to the agencies 106 or event personnel 108. In an exemplary embodiment, the event coordinator 104 ships the kits directly to the event personnel 108 assigned to the corresponding events. The kits may include, for example, samples of the product to distribute, disposable utensils, sanitary gloves, aprons, instructions, coupons, promotional items, advertisements to display, combinations of the forgoing, or the like.

The event coordinator 104 also groups the retail stores 110 with event dates and times and assigns the agencies 106 to respective events. In an embodiment, the event coordinator 104 assigns the agencies 106 to promotional events based at least in part on the corresponding retail stores 110 where the events will take place. For example, the event coordinator 104 may agree with an agency 106 to assign events at a particular retail store 110 or a chain of retail stores 110 to the agency 106. In some embodiments, the event coordinator 104 assigns the agencies 106 to promotional events based at least in part on the geographical location of where the events will take place.

In defining the promotional events, the event coordinator 104 also generates event profiles 122. The event profiles 122 include specified attributes for event personnel who will operate the events. The attributes include, for example, physical characteristics, skills, or other qualifications. The event profiles 122 can be determined by the event coordinator 104, product manufacturer 102, or both. Preferably, the attributes are selected to increase the success of the event and include, for example, the exemplary attributes discussed above. The success of an event can be increased, for example, by increasing public exposure to a product or service, distributing more samples or promotional materials, presenting more of a positive or believable impression of the product or service, presenting more information to potential consumers, selling more products or services, combinations of the forgoing, or the like. In an exemplary embodiment, the event coordinator 104 offers a higher rate of compensation to one or more agencies 106 that staff the promotional events with event personnel 108 who possess the attributes defined in the event profiles 122. Preferably, the agencies 106, in turn, offer higher rates of compensation to event personnel 108 who possess the attributes defined in the event profiles 122.

The event coordinator 104 contracts with the agencies 106 to provide event personnel 108 for the events assigned to the respective agencies 106. The event personnel 108 comprise individual event operators respectively employed by the agencies 106 and assigned to work at specific retail stores 110 for specific promotional events. The term “employee” is used herein to include independent contractors. Although not shown, the event coordinator 104 can also act as an agency by employing event operators who are assigned to work at event locations during specific events.

The agencies 106 generate or maintain employee profiles 124 of individual event operators corresponding to their respective event personnel 108. The employee profiles 124 include attributes such as physical characteristics, skills, or other qualifications and can be selected, for example, from the exemplary attributes discussed above. In an embodiment, the event coordinator 104 has access to the respective employee profiles 124 of the agencies 106 and can use the employee profiles, for example, when selecting an agency 106 to assign to an event.

The agencies 106 assign their respective event personnel 108 to promotional events based at least in part on the employee profiles 124 that correspond to the event profiles 122. For example, a promotional event to distribute free samples of women's skin care products may include an event profile 122 for a female event operator having a clear complexion and experience applying makeup or other cosmetics. The agency 106 assigned to the event can search its database of employee profiles 124 to find event personnel 108 who are female, have clear complexions, and are experienced applying makeup or other cosmetics. The agency 106 can then select an event operator from the qualified event personnel 108 identified by the search and assign the selected event operator to staff the event.

In addition, or in alternative embodiments, event personnel 108 can schedule or “book” events to participate in over a network, such as the Internet. Thus, for example, an event operator can log onto a web site to directly view and schedule events having event profiles that match or are similar to the event operator's employee profile 124.

To coordinate events, data is passed between the event coordinator 104, the agencies 106, and the event personnel 108. For example, the event coordinator 104 may transmit general guidelines, variations of instructions, the event profiles 122, and other information related to promotional events to the agencies 106. The other information can include, for example, store report forms comprising questions to be completed by the event personnel 108 and returned to the agency 106 or event coordinator 104 to evaluate the event. The event operator 104 can receive data indicating the number of samples or advertising materials distributed and the work performance of event personnel 108. Based on the data received by the event coordinator 104, the event coordinator 104 provides further instructions to the agencies 106 or event personnel 108. The event coordinator 104 generates and sends a report 130 to the product manufacturer 102 based on the data received concerning an event.

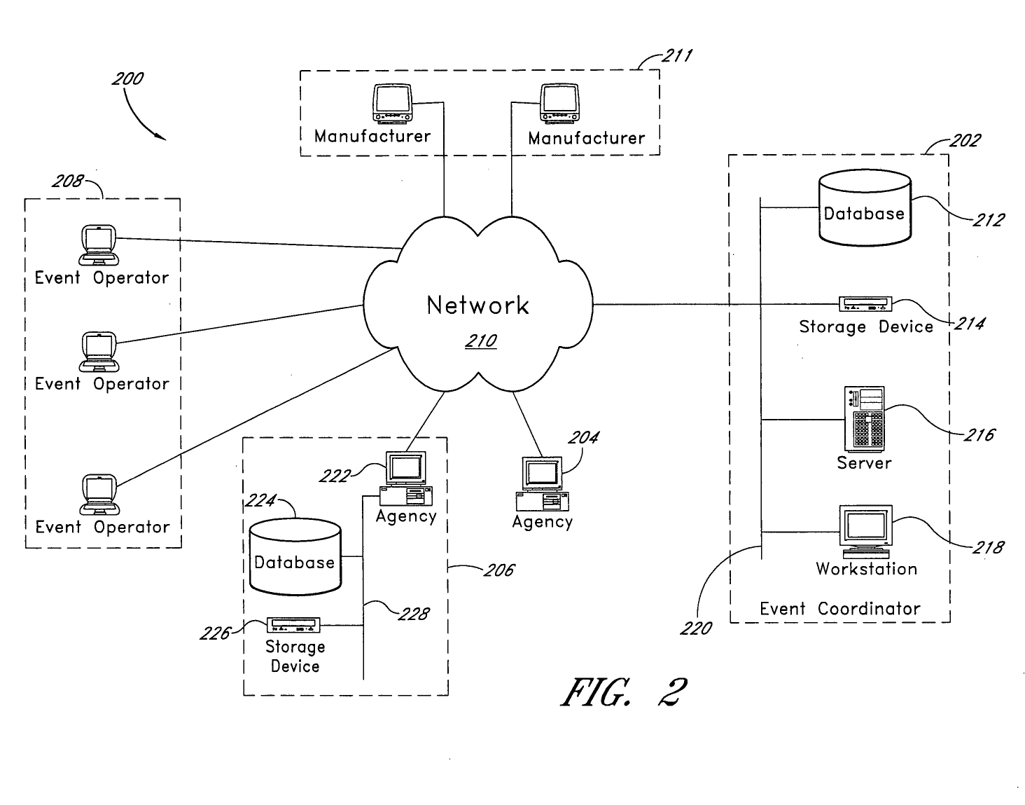

FIG. 2 is a block diagram of a system 200 according to an embodiment of the invention for coordinating a marketing event. The system 200 is configured to process and transfer information between the entities involved in a marketing event and includes an event coordinator system 202, agency systems 204, 206 and event operator systems 208 (three shown) coupled through a network 210. In certain embodiments, the system 200 also includes manufacturer systems 211 (two shown) or retailer systems (not shown). The network 210 can include, for example, a local area network (LAN), a wide area network (WAN), the Internet, or other connection services and network variations such as the world wide web, the public internet, a private internet, a private computer network, a secure internet, a private network, a public network, a value-added network, combinations of the foregoing or the like.

The event coordinator system 202, agency systems 204, 206, event operator systems 208 and manufacturer systems 211 can include, for example, computers comprising any microprocessor controlled device that permits access to the network 210, including terminal devices, such as personal computers, workstations, servers, mini-computers, hand-held computers, main-frame computers, laptop computers, mobile computers, set top boxes for televisions, combinations thereof, or the like. The computers may further include input devices such as a keyboard or a mouse, and output devices such as a computer screen, a printer or a speaker.

The event coordinator system 202 includes a database 212, a storage device 214, a server 216 and a workstation 218 interconnected through a LAN 220. The database 212 comprises event data useful for coordinating events and may include, for example, information related to manufacturers, service providers, agencies, event personnel, retail stores, event specifications, or the like. The storage device 214 includes at least one software application that can be executed by the server 216 to coordinate an event as described herein. Thus, event data can be exchanged between the event coordinator system 202 and the agency systems 204, 206 or event operator systems 208 through the network 210.

In certain embodiments, the agency systems 204, 206 can execute software applications hosted by the server 216 and can directly access or update the event data stored in the event coordinator system's database 212. In addition, or in other embodiments, the agency systems 204, 206 are standalone systems that can execute software programs to staff or coordinate events and update event data without being connected to the event coordinator system 202 and/or the network 210. In certain such embodiments, the agency systems 204, 206 are standalone systems that can execute software programs to staff or coordinate events and update event data without any communication or relationship with the event coordinator. For example, the agency system 206 can operate as a standalone system and includes at least a computer 222, a database 224 and a storage device 226 interconnected through a LAN 228. The database 224 comprises event data useful for coordinating or staffing an event. The storage device 226 includes at least one software application that can be executed by the computer 222 to coordinate or staff an event as described herein.

In some standalone systems, event data can be exchanged between the event coordinator system 202 and the agency systems 204, 206 through the network. For example, the event coordinator system 202 may coordinate events by tracking or updating at least a portion of the event data stored in the agency's database 224. Thus, the agency system 206 can receive updated event data from the event coordinator system 202 and can transfer at least a portion of the event data stored in its database 224 to the event coordinator's database 212. Event data can be exchanged between the databases 212, 224 through the network 210 when desired or at prescheduled times. In an exemplary embodiment, event data is exchanged between the databases 212, 224 at night or at the end of a business day.

An artisan will recognize that the databases 212, 224, storage devices 214, 226, and workstation 218 or computer 222 of the respective event coordinator system 202 or agency system 206 can be implemented on one or more computers. These computers may be single-processor or multiprocessor machines. An artisan will also recognize that the databases 212, 224 can be part of their respective storage devices 214, 226.

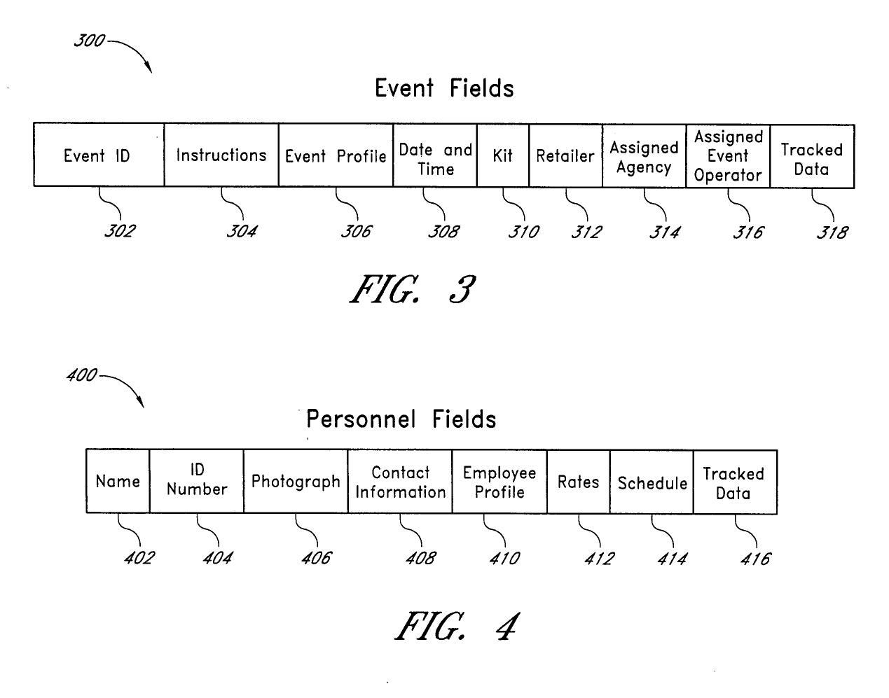

The event data that can be stored by the event coordinator system's database 212, the agency's database 224, or both databases 212, 224 may include, for example, event fields and personnel fields. The event fields comprise data useful by the event coordinator system 202 or agency system 206 to coordinate events. FIG. 3 illustrates a set 300 of exemplary event fields usable by the event coordinator system 202 or agency system 206 according to an embodiment of the invention. By way of example, nine event fields are illustrated in FIG. 3. The event fields include an event ID field 302, an instructions field 304, an event profile field 306, a date and time field 308, a kit field 310, a retailer field 312, an assigned agency field 314, an assigned event operator field 316 and a tracked data field 318. An artisan will recognize that the event fields can be combined or broken down into additional sub-fields and that any number of fields can be added or removed.

The event ID field 302 comprises a unique identifier for a specific event and can be used to identify, for example, a corresponding product manufacturer, service provider, distributor, marketer, or the like. The event ID field 302 can also include information to identify a budget or related events, products or services. The instructions field 304 may include, for example, a description of products or services to be demonstrated, the configuration of a table or booth for conducting the demonstration including placement of advertising material or the like, recipes for preparing any food products to be distributed, event time and location information, combinations of the foregoing, or the like.

The event profile field 306 comprises event personnel attributes. The attributes include, for example, the exemplary physical characteristics, skills or other qualifications described above. The date and time field 308 specifies when the event is to take place, is taking place, or has taken place. The kit field 310 includes a list of materials to be sent to the agency in the assigned agency field 314 or the operator in the assigned event operator field 316 to use for the event. The kit field 310 may also include, for example, kit preparation, shipping and tracking information. The retailer field 312 specifies the location of the event. The tracked data field 318 comprises status information for the event including, for example, financial information (such as purchases made by the event coordinator or whether the event operator has been paid for the event), shipping information, event auditing information, consumer feedback information, retail store feedback information, event operator feedback information, combinations of the foregoing, or the like.

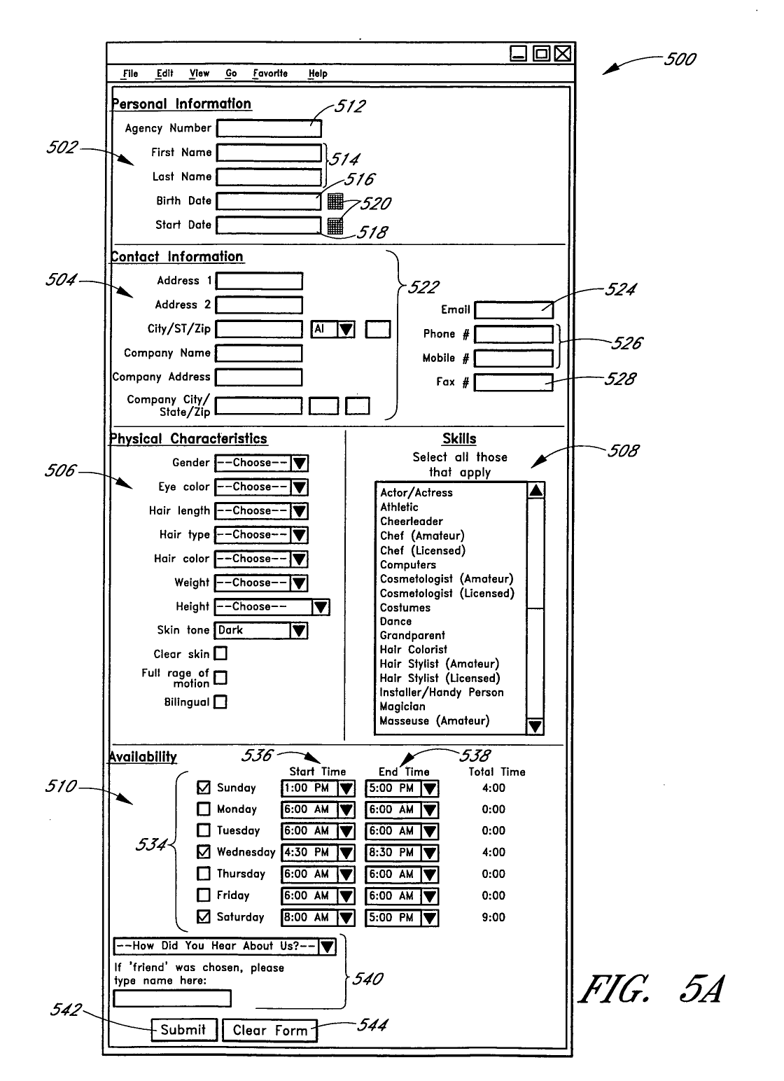

As discussed above, the event data stored by the event coordinator system's database 212, the agency system's database 224, or both databases 212, 224 may include personnel fields. The personnel fields comprise data useful by the event coordinator system 202 or agency system 206 to staff events. FIG. 4 illustrates exemplary set 400 of personnel fields usable by the event coordinator system 202 or agency system 206 according to an embodiment of the invention. By way of example, seven personnel fields are illustrated in FIG. 4. The personnel fields include a name field 402, an ID number field 404, a photograph field 406, a contact information field 408, an employee profile field 410, a rates field 412, a schedule field 414 and a tracked data field 416. An artisan will recognize that the personnel fields can be combined or broken down into additional sub-fields and that any number of fields can be added or removed.

The name field 402, the ID number field 404 and the contact information field 408 comprise data to uniquely identify an individual event operator and can include employment information generally used by employers such as staffing agencies or other companies that deal with employees or contractors. Thus, for example, the name field 402, the ID number field 404 or the contact information field 408 may include tax, insurance, security background check, employment history, salary, salary history, disciplinary actions, combinations of the foregoing, or similar information. The ID number field 404 may comprise, for example, a unique identifier assigned to the event operator. The photograph field 406 comprises, for example, a digital photograph of the event operator.

The employee profile field 410 comprises attributes of the event operator including, for example, the exemplary physical characteristics, skills or other qualifications described above. The rates field 412 comprises one or more prices (e.g., flat rate or per hour) charged by the agency employing the event operator to staff the event. For example, the rates field 412 can have a first rate for events that do not require the event operator to have particular attributes, a second rate for events that do require the event operator to have particular attributes, a third rate for events that the event operator registers for online, combinations of the foregoing, or the like. In an exemplary embodiment, the event operator is paid an enhanced rate as an incentive to register to participate in promotional events online.

The schedule field 414 comprises a list of events that the event operator is registered to participate in. The schedule field 414 may include, for example, event ID numbers, event times, event places, kit information, combinations of the foregoing, or the like. The tracked data field 318 comprises status information regarding the performance of the event operator for one or more events. In an embodiment, the performance of the event operator is based at least in part on factors such as the event operator's scheduled or unscheduled cancellation history, the number of times the event operator has provided feedback to the agency or event coordinator after an event, the audit history corresponding to the event operator, the event operator's compliance with specific or general instructions, combinations of the foregoing, or the like.

In certain embodiments, the server 216 in the event coordinator system 202 shown in FIG. 2 hosts one or more user interfaces, such as web pages or the like, for coordinating events. For example, the server 216 may host an agency website accessible by the agency systems 204, 206 through the network 210. By logging into the agency website, the agency systems 204, 206 can access, download or directly update event data in the event coordinator system's database 212. In an embodiment, the agency systems 204, 206 have exclusive access to respective portions of the database 212 corresponding to their assigned events. The event coordinator system 202 may notify an agency system 204, 206 that it has been assigned to an event by, for example, posting new event data in the portion of the database 212 corresponding to the respective agency system 204, 206. The event coordinator system 202 can further coordinate events by updating the event data in the respective portions of the database 212.

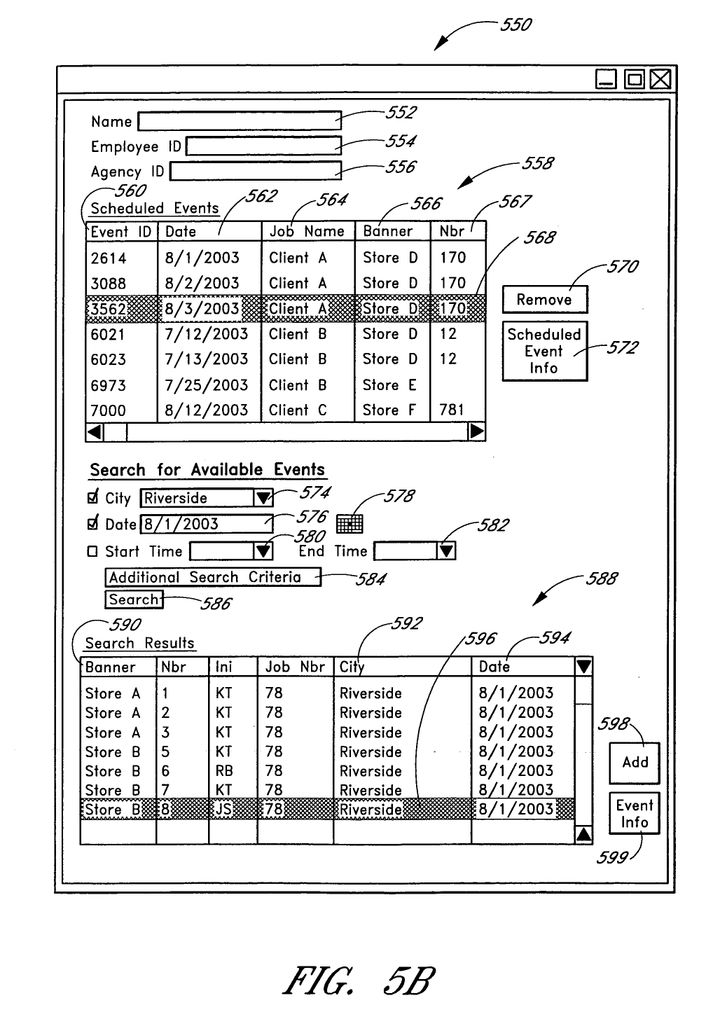

The server 216 may also host, for example, one or more event personnel websites accessible by the event operator systems 208 through the network 210. In an exemplary embodiment, the server 212 hosts a profiling website that allows agencies or event personnel to create or modify employee profiles. The profiling website can also be used to recruit or allow new event personnel to provide profile information. FIG. 5A is a representation of one embodiment of a web page 500 for entering profile information into the system 200. The web page 500 includes a personal information section 502, a contact information section 504, a physical characteristics section 506, a skills section 508 and an availability section 510.

The personal information section 502 includes data entry fields for an agency number (field 512), name (field 514), birth date (field 516) and start date (field 518). The web page 500 may also include hypertext links 520 to calendar programs to assist a user in entering date information. The agency number field 512 is used to correlate agencies with event operators. Thus, for example, agencies may provide their employees with an agency number so they can register or enter employee profile information online. In an embodiment, an agency is assigned to an event operator who submits information using the web page 500 without providing an agency number in the agency number field 512. Thus, the web page 500 can be used to recruit new event operators who are not employed by or registered with an agency.

The contact information section 504 includes data entry fields for address (field 522), Email (field 524), telephone (field 526) and fax (field 528). The physical characteristics section 506 and skills section 508 allow a user to enter attributes corresponding to the event operator including, for example, the exemplary physical characteristics, skills and other qualifications described above. The availability section 510 allows a user to specify when the event operator is willing to staff events and includes data entry fields for available days (field 534) and corresponding start times (field 536) and end times (field 538). The web page can also include fields for referral information (field 540) as well as a “Submit” control button 542 (or hypertext) to submit the employee profile information and a “Clear Form” button 544 (or hypertext) to clear the information from the web page 500.

In an exemplary embodiment, the server 212 hosts an event booking website that allows event personnel to view and schedule events to participate in. The event personnel provide login information that includes data used to associate individual event operators with a respective agency system 204, 206 that the event operator is registered with, for example, as an employee. Thus, the event booking website allows event personnel to view and register for only those events assigned to their respective agencies.

The event operator systems 208 can access respective individual event operator schedules through the event booking website and can add or remove events from their schedules. In an embodiment, the event operator systems 208 can only access and register for those events for which they are qualified. Qualification may be based, for example, on such factors as whether an event conflicts with another event already scheduled by the event operator, whether the event is assigned to the event operator's corresponding agency, or whether the event operator's employee profile matches or is similar to the event profile.

FIG. 5B is a representation of an embodiment of a web page 550 accessible by the event operator systems 208 for booking events. The web page 550 displays a name field 552, a unique employee ID field 554 and an Agency ID field 556 associated with a particular event operator logged into the web page 550. The web page 550 also displays a scheduled events list 558 that the particular event operator is scheduled to participate in. The scheduled events list 558 includes event information such as a unique event identification number entry 560, a date of the event entry 562 of the event, an entry 564 for a job name corresponding to the event, a Banner entry 566 that indicates a retail store where the event will take place, and an entry 567 for a job number corresponding to the event.

A user can select an entry in the scheduled events list 558 (e.g., a highlighted event 568) and click on a “Remove” button 570 to remove the selected event 568 from the particular event operator's schedule. The user can also click on a “Scheduled Event Info” button 572 to view additional information for the selected event 568 including, for example, instructions for conducting the event, materials needed for the event, the address of the event, and contact information for additional event questions. In an embodiment, the Scheduled Event Info button 572 also allows the user to directly email an event supervisor.

The web page 550 is also configured to allow the user to book additional events that are added to the scheduled events list 558. The user can search for events to participate in by specifying one or more cities in a field 574 and the date in a field 576 when the events are to take place. The web page 550 may also include a hypertext link 578 to calendar programs to assist the user in entering date information. The user can further define the search criteria by selecting a start time in a field 580 and an end time in a field 582 for the events and by clicking on an “Additional Search Criteria” button 584. The Additional Search Criteria button 584 may allow the user to specify, for example, certain event profiles or certain retail stores to search for. The user can then press a “Search” button 586 to perform the search.

The web page 550 is configured to display the search results in a search results list 588 which lists one or more events that the particular event operator is qualified to participate in based at least in part on the search criteria and the particular event operator's employee profile. The search results list 588 displays a Banner field 590 that indicates retail stores corresponding to the events, a city field 592 that indicates the cities the events will occur in and a date field 594 that indicates when the events are to take place. The user can select an event (e.g., a highlighted event 596) from the search results list 588 and click on an “Add” button 598 to book the selected event 596. The selected event 596 is then displayed in the scheduled events list 558. The user can also click on an “Event Info” button 599 to view additional information for the selected event 596 including, for example, instructions for conducting the event, materials needed for the event, the address of the event, and contact information for additional event questions. In an embodiment, the Event Info button 599 also allows the user to directly email an event supervisor.

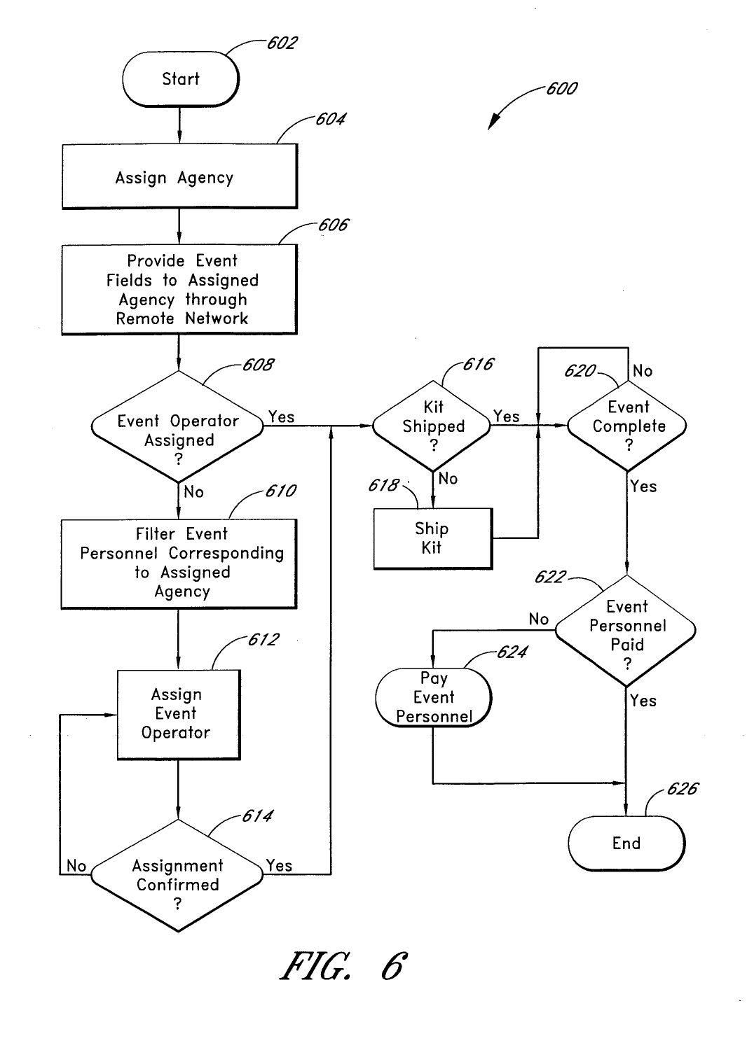

FIG. 6 is a flow chart illustrating portions of an event coordination process 600 usable by the system shown in FIG. 2 according to an embodiment of the invention. The process 600 begins in a block 602. In a block 604, an event coordinator assigns an agency to staff a promotional event. The agency may be assigned based at least in part on such factors as when the event will take place, the geographical location of the event, a retail store where the event will take place, an agreement between the event operator and the agency, event personnel attributes requested for the event, combinations of the foregoing or the like. In a block 606, the event coordinator provides event fields to the assigned agency through a remote network. The event fields may be provided through, for example, a dial-up connection or through a web page accessible by the assigned agency. The event fields may include, for example, one or more of the event fields 300 shown in FIG. 3.

In a block 608, the process 600 queries whether an event operator has been assigned to participate in the promotional event. If no, the process 600 advances to a block 610 where the system filters the event personnel corresponding to the assigned agency to determine those event personnel qualified to participate in the event. The filtering may be based on such factors as schedule availability, city where the event will take place, distance of the event to event personnel homes or other specified locations, pay rates, employee profiles, event profiles, combinations of the foregoing or the like. In an exemplary embodiment, employee profiles are compared to the event profile to determine event personnel having desired attributes for the event. The filtering may produce, for example, a list of qualified event personnel to staff the event.

In a block 612, an event operator is assigned to participate in the event. In an embodiment, the agency assigned to staff the event selects the event operator from the list of qualified event personnel. In addition, or in other embodiments, a qualified event operator can sign up to participate in the event online from a remote location using, for example, a web browser. In a block 614, the assignment made by the agency or scheduled by the event operator is confirmed with the event operator. In an exemplary embodiment, the agency and event operator communicate through the remote network to make the confirmation.

Once an event operator has been assigned to participate in the promotional event, the process 600 proceeds to a block 616 in which the process 600 queries whether a kit has been shipped to the assigned event operator. If no, a kit is shipped to the event operator in a block 618. As discussed above, the kit may include, for example, samples of the product to distribute, disposable utensils, sanitary gloves, aprons, instructions, coupons, promotional items, advertisements to display, and the like. Also discussed above, the shipment can be tracked and tracking information including the location of the kit and whether it has been delivered can be provided through the remote network to the event coordinator, assigned agency or assigned event operator. An artisan will understand from the disclosure herein that a kit may not always be prepared or shipped. For example, products to be distributed to potential customers during the event may be purchased by the event operator at the retail store where the event occurs.

In a block 620, the process 600 queries whether the event is complete or should have been completed. If the event is not completed, the process 600 waits in the block 620 until the event is complete or should have been completed. Although not shown, the process 600 may continue to monitor and coordinate the event in the block 620 while waiting for the event to be completed. For example, the event coordinator or agency may continue to provide instructions or materials to the event operator or may reschedule event personnel due to event operators who unexpectedly cancel their participation in events.

Once the promotional event is complete, the process 600 proceeds to a block 622 in which the process 600 queries whether the event personnel have been paid. If the response is no, the event personnel are paid in a block 624 and the process 600 ends in a block 626. In some embodiments, the process 600 also tracks other financial information in a block 622 such as the amount to be paid to the event personnel, whether the payment has been approved, and other accounting and payroll processes known in the art. At least a portion of the financial information may be made available to the event coordinator, agency or event personnel through, for example, the remote network. For example, event personnel may be able to determine when they will be paid for specific events by logging on to a secure website that displays payment information.

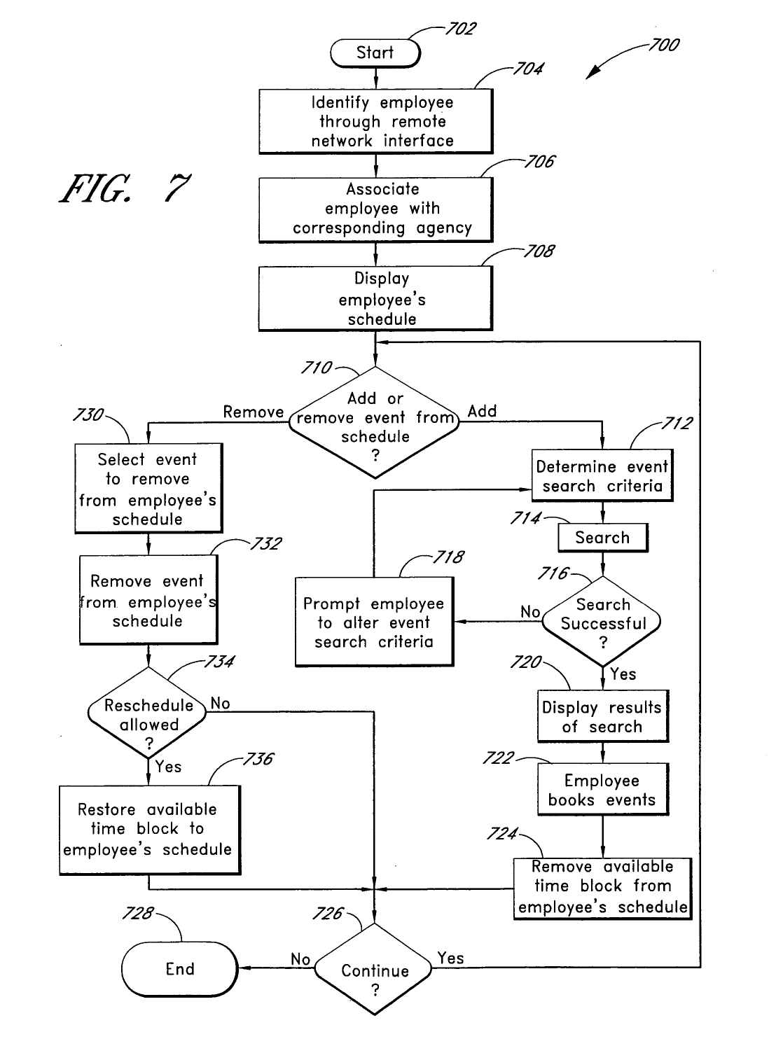

FIG. 7 is a flow chart illustrating portions of a promotional event booking process 700 usable by the system shown in FIG. 2 according to an embodiment of the invention. The process 700 begins in a block 702 and proceeds to a block 704 where the system identifies an employee through a remote network interface. The employee may work for an event coordinator or an agency, and can be, for example, a contractor of the foregoing. The employee may be an event operator, an event auditor, or another individual or entity hired to operate, staff, track, coordinate or otherwise participate in events. The employee provides identifying login information through the remote network interface. The remote network interface may be, for example, a web page or other user interface that allows the employee to login to a network.

In a block 706, the system associates the employee with a corresponding agency that is assigned to staff one or more events. For example, an employee hired by an agency to operate promotional events will be associated with that agency. As another example, an employee of an event coordinator may be associated with one or more agencies with which they will coordinate, audit, or track events. However, in some embodiments, an employee of an event coordinator is not associated with a corresponding agency in a block 706.

In a block 708, the process 700 displays the employee's schedule. The employee's schedule includes a plurality of time blocks that indicate when the employee is scheduled or is not scheduled to participate in a promotional event. For example, the employee's schedule may include available time blocks when events can be scheduled and unavailable time blocks when events cannot be scheduled (for example, times or days when other events are already scheduled). The displayed employee's schedule may list, for example, the names, identification numbers, times, locations, materials, supervisors, instructions, other scheduling information, combinations of the foregoing, or the like of scheduled events. In a block 710, the system queries whether the employee wants to add or remove an event from the displayed schedule.

To add an event to the employee's schedule, the process 700 advances to a block 712 in which the system determines event search criteria. The event search criteria are based at least in part on the events assigned to the employee's associated agency that have not been staffed yet and that would fit into the employee's schedule. In an embodiment, an employee can select at least a portion of the search criteria by specifying a location where and/or a time period during which the employee wants to participate in an event. For example, upon logging onto a web page, an employee may search for available events assigned to the employee's agency that occur on a certain day or at a certain time in a certain city.

In an exemplary embodiment, the search criteria are also based at least in part on the employee's profile. Thus, the system will specify that only those events having event profiles that match or are similar to the physical characteristics, skills or other qualifications in the employee's profile will be displayed to the employee. Additionally, or in other embodiments, the employee can specify one or more attributes to search for. Thus, an employee having more than one skill in his or her employee profile can search for those events that include a specific skill. For example, an employee who is both a professional chef and a makeup artist can limit the search criteria to include only events that request a makeup artist. The employee's selection of search criteria may be based at least in part on such factors as personal preference or differences in pay rates. For example, an employee may search for events that offer a higher pay rate for skills included in the employee's profile.

In a block 714, the system searches for events assigned to the corresponding agency according to the search criteria. In a block 716, the system queries whether the search was successful. A search may be successful, for example, if the search finds one or more events that meet the search criteria. An employee or the system may deem that a search is not successful if a maximum number of events are found during the search. If the search is not successful, the process proceeds to a block 718 in which the system prompts the employee to alter the event search criteria. The process 700 then returns to block the 710. The employee may alter the event search criteria in the block 712 by, for example, changing the days, times, cities, event profiles, and/or other event characteristics to search for. Thus, the employee can repeat the search in the block 714 with new or altered search criteria.

If the search is successful, the process 700 proceeds to a block 720 in which the system displays the results of the search to the employee. In a block 722, the employee books the event by selecting an event from the displayed results of the search. After the employee books the event, the system determines whether the event allows additional event personnel to schedule the event. If not, the system flags the event as being scheduled, and other event personnel cannot schedule the event. In some embodiments, additional event personnel can register as backup event operators in case a scheduled employee later decides not to participate in the event.

In a block 724, the system removes an available time block from the employee's schedule corresponding to the time when the selected event will take place and displays the selected event in the employee's schedule. Thus, the time block corresponding to the event changes from available to unavailable. The process then proceeds to a block 726. It should be understood that the employee might choose not to book an event in the block 722. In such circumstances, the process proceeds to the block 726 without removing the available time block from the employee's schedule. In the block 726, the employee decides whether to continue altering the employee's schedule or to end the process 700 at a block 728. If the employee chooses to continue, the process 700 returns to the block 710.

To remove an event, the process 700 advances from the block 710 to a block 730 in which the system prompts the employee to select an event to remove from the employee's schedule. The employee then selects an event to remove. Then, in a block 732, the system removes the selected event from the employee's schedule and makes the event available to other event personnel. The system then flags the event as unscheduled. In some embodiments, the system alerts the event coordinator or corresponding agency when an event changes status from being flagged as scheduled to being flagged as unscheduled. Thus, the event coordinator or agency can act quickly if necessary to find a replacement event operator to participate in the event.

In a block 734, the system queries whether the time block corresponding to the event removed from the employee's schedule can be rescheduled or changed from unavailable to available so that other events can be added to the employee's schedule during that time block. In an embodiment, the time block can only be rescheduled if the event is removed from the employee's schedule within a predetermined time period from when it was added to the employee's schedule. For example, after an employee adds an event to his or her schedule, the employee may be given 24 hours or some other predetermined time period to remove the event from his or her schedule and reschedule another event in its place. If the 24-hour period passes without removing the event from the schedule, the employee may still remove the event from his or her schedule, but the employee will not be allowed to reschedule another event in its place. Thus, an employee is discouraged from scheduling an event that the employee may later cancel after finding a more desirable event to participate in, which in turn may cause the agency to cancel the originally scheduled event or may cause the agency to rush to find a replacement for the originally scheduled employee.

If the system does not allow the time block to be rescheduled, the process 700 proceeds to the block 726. If the system does allow the time block to be rescheduled, the process 700 proceeds to a block 736 in which the system restores the available time block to the employee's schedule. In other words, the system changes the time block corresponding to the event removed from the employee's schedule from unavailable to available. From the block 736, the process 700 proceeds to the block 726 where the employee decides whether to continue altering the employee's schedule or to end the process 700 at the block 728.

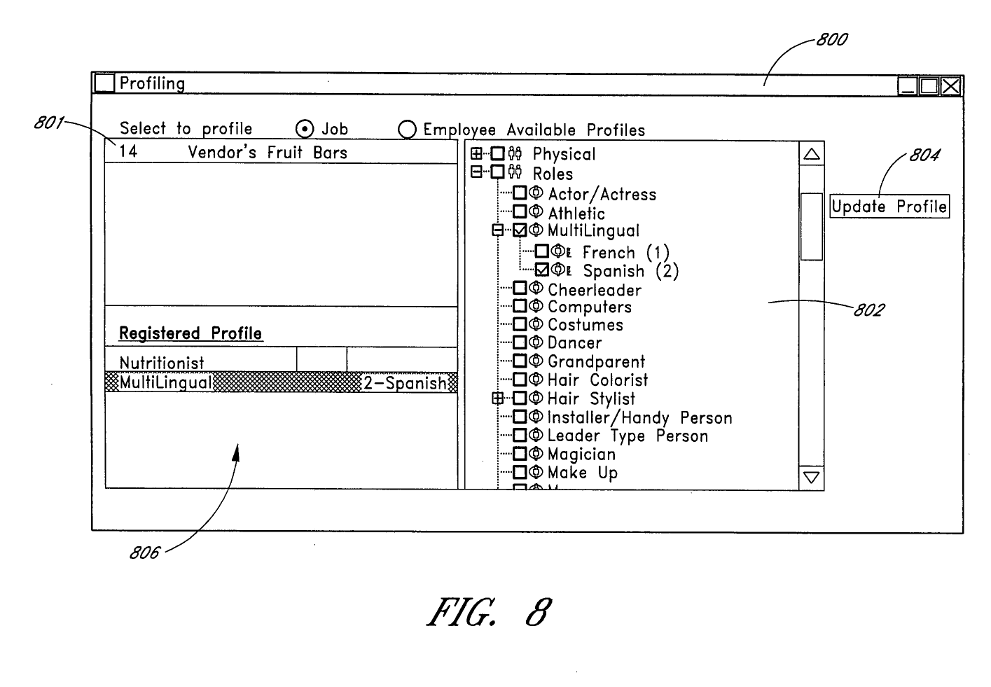

FIG. 8 generally illustrates an example of a user interface 800 that is usable to generate an event profile according to an embodiment of the invention. The user interface 800 allows a user to select a job or event to profile from a job list 801. The user interface 800 also allows the user to select desired attributes for the selected job from an available profiles list 802. The profiles in the available profiles list 802 are arranged in a tree format and may include, for example, the exemplary physical characteristics, skills (i.e., roles) or other qualifications discussed above. Attributes selected from the available profiles in the list 802 are listed in a registered profile portion 806 of the user interface 800.

A user can generate or update an event profile to specify the desired attributes of event personnel to participate in the particular job by selecting one or more of the available profiles in the list 802 and then clicking on an update profile button 804. In an embodiment, the registered profile portion 806 indicates the number of event operators employed by an agency or event coordinator who have the selected available profile in the list 802. Thus, the user may decide to adjust the event profile according to the current availability of event personnel having the particular attributes.

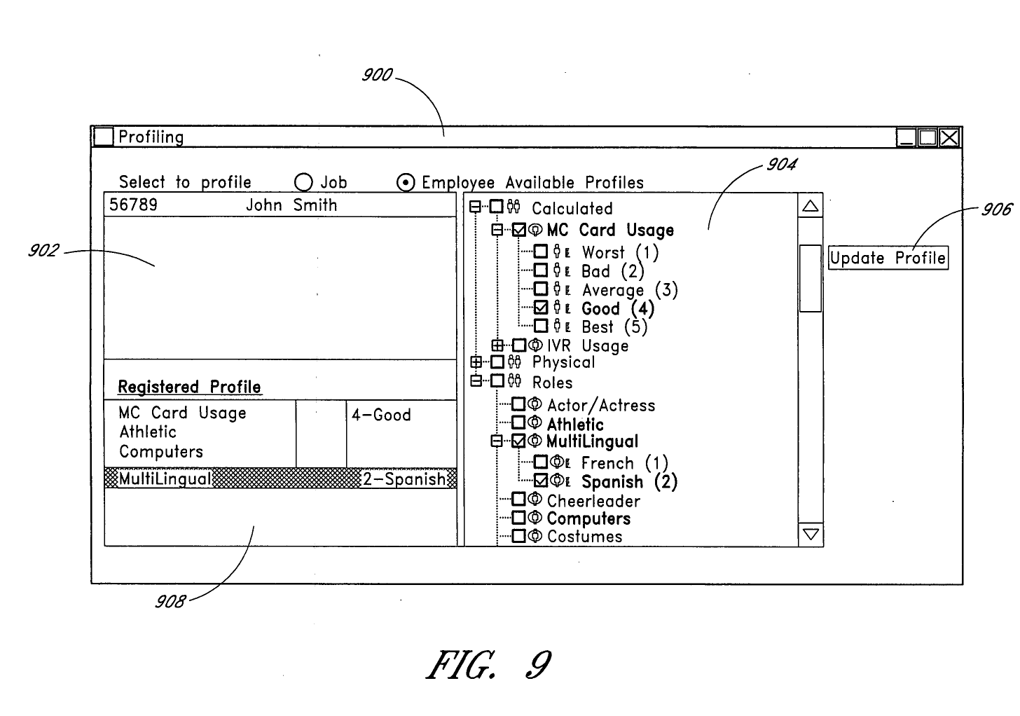

FIG. 9 generally illustrates an example of a user interface 900 that is usable to generate an employee profile according to an embodiment of the invention. The user interface 900 allows a user to select an employee to profile from an employee list 902. The user interface 900 also allows the user to select one or more attributes of the selected employee from an available profiles list 904. The available profiles in the list 904 are arranged in a tree format and may include, for example, the exemplary physical characteristics, skills (i.e., roles) or other qualifications discussed above.

A user may generate or update an event profile by selecting one or more of the available profiles in the list 904 and then clicking on an update profile button 906. Attributes selected from the available profiles in the list 904 are listed in a registered profile portion 908 of the user interface 900. For example, the registered profile in the list 908 shown in FIG. 9 indicates that the selected employee has an MC card usage rating of “good,” is athletic, has computer skills, and is multilingual (i.e., speaks Spanish).

The MC card usage rating is an example of feedback that can be used to evaluate an employee's performance or ability to follow instructions or procedures. In the example provided herein, an “MC card” is a card, such as a debit card, credit card, or smart card that an event coordinator or agency provides to an event operator to purchase items needed for an event. The event operator then contacts a card administration system that activates the card and associates an authorized budget associated with the event. (See, for example, patent application Publication No. US 2003/0229583, entitled “METHODS OF COORDINATING PRODUCTS AND SERVICE DEMONSTRATIONS,” published Dec. 11, 2003). The employee's performance in using the card as directed by the event coordinator or agency can be tracked, included in the employee's profile and taken into consideration when selecting the employee to participate in a particular event. An artisan will recognize from the disclosure herein that other forms of employee performance may be tracked and included in the employee profile including, for example, event feedback provided by the employee, an agency, an event auditor, a potential customer, a retail store, combinations of the foregoing or the like.

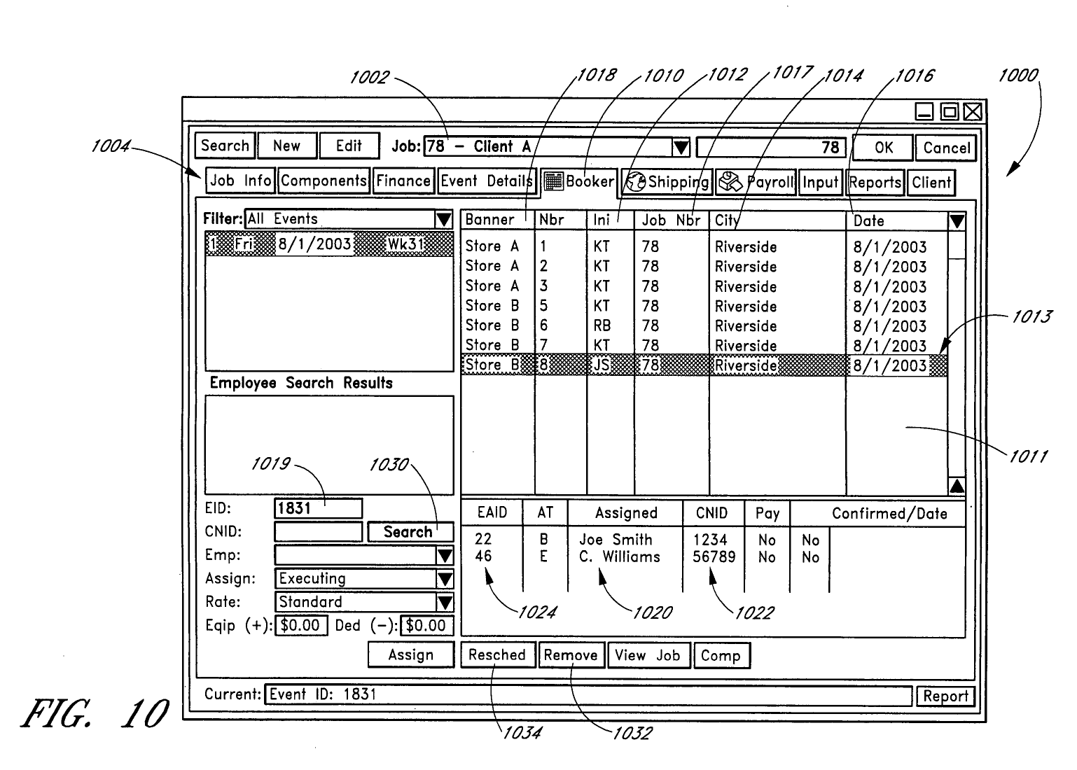

FIG. 10 generally illustrates an example of a user interface 1000 for coordinating events according to an embodiment of the invention. The user interface 1000 displays a selected job number in a field 1002 corresponding to a client of an event coordinator or an agency. The user interface 1000 comprises one or more tabs 1004 for viewing, tracking and editing information related to the displayed job number 1002. In an embodiment, the tabs 1004 include a “Booker” tab 1010 that allows a user to schedule employees for participation in one or more of the events corresponding to the displayed job number in the field 1002.

For example, in an event window 1011, FIG. 10 shows the initials (field 1012) of an employee assigned to participate in a selected event (e.g., highlighted event 1013) or the initials of the person who booked the employees assigned to participate in the selected event, the city (field 1014) where the selected event will take place, the date (field 1016) of the selected event, the job number (field 1017), and a “Banner” (field 1018) or location where the selected event will occur. In an embodiment, the Banner field 1018 comprises the name of a retail store. The booker tab 1010 displays an event identification number or “EID” number 1019 that uniquely identifies the selected event 1013. An artisan will understand from the disclosure herein that the selected event 1013 can be an event scheduled to occur in the future, an event that is currently occurring, or an event that occurred in the past.

The Booker tab 1010 also displays the names of employees assigned to participate in the selected event as a list in a field 1020 and displays corresponding identification numbers or “CNID” numbers that uniquely identify the employees in a field 1022. Upon being assigned to participate in an event, the employees whose names are displayed in the field 1022 are assigned a unique event assignment identification number or “EAID” number shown in a field 1024. The EAID number associates the selected event with the particular employee. The user can press a search button 1030 to find one or more employees to assign to participate in the selected event 1013. The Booker tab 1010 may also include, for example, a “Remove” button 1032 for removing an employee's name from the list 1020 of employees assigned to participate in the event. A “Reschedule” button 1034 is advantageously included to change the date and/or time of the selected event 1013.

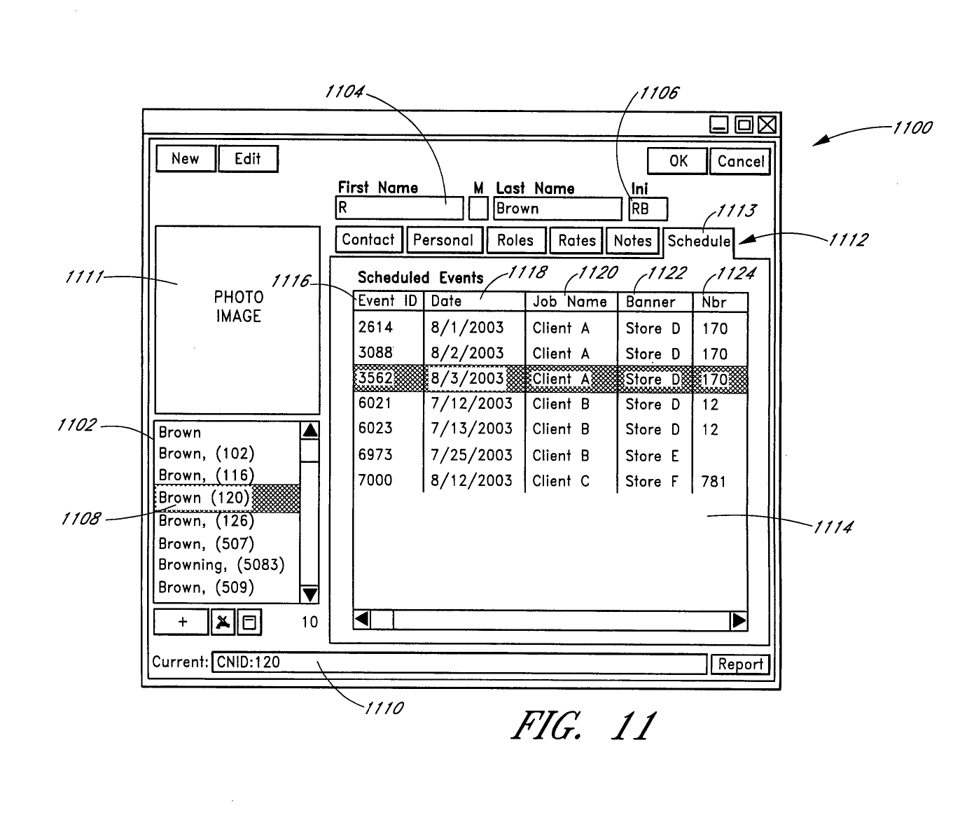

FIG. 11 generally illustrates an example of a user interface 1100 having one or more tabs 1112 for creating, viewing or altering employee information according to an embodiment of the invention. The user interface 1100 includes a list of employees in a window 1102. A field 1104 displays the name and a field 1106 displays the initials of a highlighted employee 1108 in the window 1102. The user interface 1100 also displays the CNID number of the selected employee 1108 in a field 1110. In an embodiment, the user interface 1100 includes a photograph of the selected employee 1108 in a window 1111.

The tabs 1112 include a “Schedule” tab 1113 that allows a user to view or alter the schedule of the selected employee 1108. When the Schedule tab 1113 is active, an event list 1114 is displayed for the selected employee 1108 to show the events the employee is scheduled to participate in. The event list 1114 includes information related to the scheduled events such as the event identification number in a field 1116, the date of the event in a field 1118, a job name corresponding to the event in a field 1120, a Banner of the event in a field 1122, and a job number in a field 1124.

Although the present invention has been described with reference to specific embodiments, other embodiments will occur to those skilled in the art. It is to be understood that the embodiments described above have been presented by way of example, and not limitation, and that the invention is defined by the appended claims.

What is claimed is:

1. A method for facilitating the staffing of promotional events with qualified event personnel, the method comprising:
creating a database comprising event data, wherein the event data includes schedule information for one or more promotional events, and wherein the event data includes qualifications for event personnel associated with the one or more promotional events;
receiving a first request from a user seeking to be staffed at the one or more promotional events;
determining a set of qualifications associated with the user;
filtering the event data based at least in part on the qualifications of the user to identify one or more of the promotional events for which the user is qualified to participate; and
providing the user with schedule information for promotional events for which the user is qualified to participate as identified through the filtering of the event data, wherein the information is provided through at least one web page.

2. The method of claim 1, further comprising receiving a second request from the user through the at least one web page to alter the schedule information, wherein the second request is based at least in part on the filtered event data.

3. The method of claim 2, wherein receiving the second request to alter the schedule information comprises receiving event identification information through the at least one web page, the event identification information corresponding to an event selected by the user from the one or more promotional events identified through the filtering of the event data.

4. The method of claim 3, further comprising adding the event selected by the event operator to a schedule of promotional events assigned to the user.

5. The method of claim 1, further comprising identifying the user by receiving login information from the user through the at least one web page.

6. The method of claim 5, wherein filtering the event data further comprises identifying events corresponding to a time block when the user is available to participate.

7. The method of claim 5, wherein the user is associated with an agency.

8. The method of claim 7, wherein filtering the event data comprises determining at least a portion of the event data that is assigned to the corresponding agency for staffing promotional events.

9. The method of claim 1, further comprising displaying the schedule information through the at least one web page.

10. The method of claim 1, further comprising paying the user a predetermined amount as an incentive to use the at least one web page to select the promotional events at which the user seeks to be staffed.

11. The method of claim 1, wherein filtering the event data further comprises:
receiving event specifications from the user through the at least one web page; and
selecting the one or more promotional events based at least in part on the event specifications.

12. The method of claim 11, wherein receiving the event specifications comprises receiving one or more event criteria selected from the group comprising event times, event cities, event locations, retail stores where the events will take place, products demonstrated in the events, services demonstrated in the events, and event profiles.

13. A system for booking promotional events, the system comprising:
a database comprising:
event fields corresponding to one or more promotional events;
employee fields corresponding to an event operator; and
schedule information for coordinating the event operator's participation in booked events selected from the one or more events; and
a server that provides the event operator with remote access to the database via a web page, wherein the server is configured to compare the event fields to the employee fields and to receive a request from the event operator to update the schedule information based at least in part on the comparison.

14. The system of claim 13, wherein the event fields comprise event profile information for specifying event personnel attributes for the one or more events, and wherein the employee fields comprise employee profile information comprising attributes of the event operator.

15. The system of claim 14, wherein the server is configured to compare at least the employee profile information to the event profile information.

16. The system of claim 13, wherein the event fields comprise time information specifying when the one or more events are scheduled to take place.

17. The system of claim 16, wherein the server is configured to compare at least the time information with the schedule information to determine qualifying events of the one or more events that correspond to an available time block when the event operator is available to participate.

18. The system of claim 13, wherein the event fields comprise agency information for determining one or more agencies respectively assigned to staff the one or more events, and wherein the employee fields comprise employer information indicating that the event operator is associated with at least one of the one or more agencies.

19. The system of claim 18, wherein the server is configured to compare at least the agency information to the employer information.

20. The system of claim 13, wherein the server is further configured to display the schedule information through the web page.

21. A computer-implemented method of gathering event personnel attributes from an event operator seeking to be staffed at promotional events, the method comprising:
providing a graphical user interface accessible over a computer network containing selectable entries for a plurality of personnel attributes associated with promotional events;
receiving from the event operator selections from one or more of the selectable entries, the event operator accessing the graphical user interface over a computer network;
storing the event operator selections; and
associating the event operator selections with an identifier assigned to the event operator.

22. The method of claim 21, wherein the selectable entries of the graphical user interface includes the selection of a gender.

23. The method of claim 21, wherein the selectable entries of the graphical user interface includes the selection of eye color, hair color, and hair type.

24. The method of claim 21, wherein the selectable entries of the graphical user interface includes the selection of a height and a weight.

25. The method of claim 21, wherein the selectable entries of the graphical user interface includes the selection of one or more languages spoken by the event operator.

26. The method of claim 21, wherein the selectable entries of the graphical user interface includes the selection of professional training associated with the event operator.

27. The method of claim 21, wherein the selectable entries of the graphical user interface includes the selection of information on times of day and days of the week for which the event operator expects to be available.

28. A system for gathering event personnel attributes from an event operator seeking to be staffed at promotional events, the system comprising:
a graphical user interface in communication with a computer network, the graphical user interface containing selectable entries for a plurality of personnel attributes associated with promotional events;
a first database in communication with the graphical user interface, the first database configured for storing personnel attribute selections from event operators accessing the graphical user interface; and
a second database in communication with the first database, the second database containing an identifier associated with the event operator and further associated with the personnel attribute selections of the event operator stored in the first database.

29. The system of claim 28, wherein the graphical user interface includes selectable entries for one or more of:
an event operator's gender;
an event operator's eye color, hair color, and hair type;
an event operator's height and weight;
languages spoken by the event operator; and
professional training associated with the event operator.

30. The system of claim 28, wherein the graphical user interface includes selectable entries for information on times of day and days of the week for which the event operator expects to be available.

31. A method of staffing promotional events, the method comprising:
(a) for each of a plurality of event operators seeking to be staffed at promotional events, generating and storing an employee profile for the event operator that includes personnel attributes for subsequently determining whether the event operator may qualify to be staffed at particular promotional events;
(b) receiving an order to staff a promotional event;
(c) receiving an event profile corresponding to the promotional event, wherein the event profile specifies at least one attribute of event personnel qualified to participate in the promotional event;
(d) comparing the event profile received to the employee profiles generated and stored for the plurality of event operators;
(e) in response to (d), identifying one or more qualified event operators; and
(f) assigning the one or more qualified event operators to participate in the promotional event.

32. The method of claim 31, further comprising generating and storing a schedule for each of the plurality of event operators, including date and store information for promotions for which the event operator is assigned.

33. The method of claim 31, further comprising the one or more qualified event operators are employees of an agency.

34. The method of claim 33, wherein the agency is assigned to staff the promotional event based at least in part on one or more factors selected from the group comprising the geographical location of the promotional event, the time of the promotional event, a retail store where the promotional event will take place, an agreement between an event coordinator and the assigned agency, and the availability of event personnel employed by the agency with employee profiles matching the event profile.

35. The method of claim 33, further comprising communicating the event profile to the assigned agency through a computer network.

36. A system for staffing promotional events, the system comprising:
a database comprising:
an event profile corresponding to a promotional event, wherein the event profile specifies at least one attribute of event personnel qualified to participate in the promotional event; and
a plurality of employee profiles comprising event personnel attributes; and
a computer configured to compare the event profile to the plurality of employee profiles to identify one or more qualified event operators, wherein the computer is further configured to assign the one or more qualified event operators to participate in the promotional event.

37. The system of claim 36, wherein the computer is further configured to communicate the event profile through a computer network to an agency system assigned to staff the promotional event.

38. The system of claim 37, wherein the agency system is configured to generate at least a portion of the plurality of employee profiles.

39. The system of claim 36, wherein the system is configured to be operated by an agency to staff promotional events.

40. The system of claim 36, wherein the computer is further configured to receive a confirmation from the one or more qualified event operators indicating that the one or more event operators agree to participate in the promotional event.
